(19) United States
(12) Patent Application Publication
(10) Pub. No.: US 2021/0402631 A1
(43) Pub. Date: Dec. 30, 2021

(54) CUTTING ASSEMBLY FOR MIXTURES FOR FOOD USE

(71) Applicant: MINIPAN S.R.L., Massa Lombarda (IT)

(72) Inventors: Alessandro LANDI, Bagnacavallo (IT); Marco FOSSA, Cotignola (IT)

(21) Appl. No.: 17/360,212

(22) Filed: Jun. 28, 2021

(30) Foreign Application Priority Data
Jun. 30, 2020 (IT) 202020000003778

(51) Int. Cl. B26D 1/06; A23P 30/20; B26D 7/06

(52) U.S. Cl. CPC B26D 1/06; B26D 7/0625; A23P 30/20

(57) ABSTRACT

A cutting assembly for mixtures for food use which is adapted for functional connection to a dispensing apparatus of at least one continuous element constituted by a mixture for food use, and which is provided with at least one cutter facing toward the exit of the dispensing apparatus.

A cutting assembly includes a fixed frame which is rigidly coupled, and proximate, to the dispensing apparatus, at least one motorized automatic follower mechanism, supporting the at least one cutter and coupled to the frame, and a control and management unit controlled by the dispensing apparatus and designed to control the at least one actuator of the at least one motorized automatic follower mechanism.

### CROSS REFERENCE TO RELATED APPLICATIONS

This application claims priority to Italian Utility Model Application No. 202020000003778, filed on Jun. 30, 2020, the contents of which are hereby incorporated by reference in their entirety.

### TECHNICAL FIELD

The present disclosure relates to a cutting assembly for mixtures for food use: in particular the assembly is adapted to be installed downstream of an extruder, for the purpose of severing the mixture flowing out therefrom according to preset dimensions.

### BACKGROUND

The mixtures for food use are generally obtained via the processing of flours (which can be of various types) with water and other ingredients.

These mixtures undergo a rising process at the end of which they can be subdivided into portions of predefined volume, or mass, which will be given specific shapes.

The formats thus created can in turn be cut according to the final production standards of the product that it is intended to obtain, prior to being subjected to cooking.

In many cases the forming of the end product is obtained with an extrusion process in which the mixture (accommodated in a hopper) is conveyed through at least one opening (of predefined shape and dimensions) from which it exits as a continuous bar with a constant cross-section (and corresponding to the specified standards). The completion of the product (attribution of the specified length) is obtained in a subsequent step of cutting to a format.

The cutting operations are normally carried out using blades actuated with an alternating motion which, periodically, interfere with the bar of mixture flowing out from the extrusion head and subdivide it into portions of predefined length.

This type of cutting is suitable only for low to medium extrusion speeds of the mixture format.

At increased extrusion speeds, the cutting is far less precise and can lead to deformations of the portions obtained from the bar of mixture.

The use is known of rotating cutting assemblies which are provided with blades arranged according to the corners of a polygon, with a substantially radial orientation. The rotation of the assembly brings each cutter to assume the cutting configuration, with respect to the bar of mixture, cyclically.

This type of assemblies makes it possible to handle greater advancement speeds of the mixture format on the conveyor belt, but can still lead to deformations of the portions (the rotation of the cutter can push a front of the piece of mixture, modifying its shape and/or dimensions).

### SUMMARY

The principal aim of the present disclosure is to solve the above mentioned drawbacks, by providing a cutting assembly for mixtures for food use that can operate substantially at any extrusion speed of the mixture.

Within this aim, the disclosure provides a cutting assembly for mixtures for food use that is versatile, therefore adapted to execute any type of cut on the bar of mixture with any frequency.

The disclosure also provides a cutting assembly for mixtures for food use that does not damage or deform, or generically modify, the shape and/or the dimensions of the mixture.

The present disclosure further provides a cutting station for mixtures for food use which is of low cost, easily and practically implemented and safe in use.

This aim and these and other advantages that will become more apparent hereinafter are achieved by providing a cutting assembly for mixtures for food use, of the type adapted for functional connection to a dispensing apparatus of at least one continuous element constituted by a mixture for food use, and which is provided with at least one cutter facing toward the exit of said dispensing apparatus, characterized in that it comprises:
a fixed frame which is rigidly coupled, and proximate, to said dispensing apparatus,
at least one motorized automatic follower mechanism, supporting the at least one said cutter and coupled to said frame,
a control and management unit controlled by the said dispensing apparatus and designed to control the at least one actuator of said at least one motorized automatic follower mechanism.

### BRIEF DESCRIPTION OF THE DRAWINGS

Further characteristics and advantages of the disclosure will become better apparent from the detailed description that follows of a preferred, but not exclusive, embodiment of the cutting assembly for mixtures for food use according to the disclosure, which is illustrated by way of non-limiting example in the accompanying drawings, wherein:

FIG. 1 is a schematic perspective view of a cutting assembly for mixtures for food use according to the disclosure;

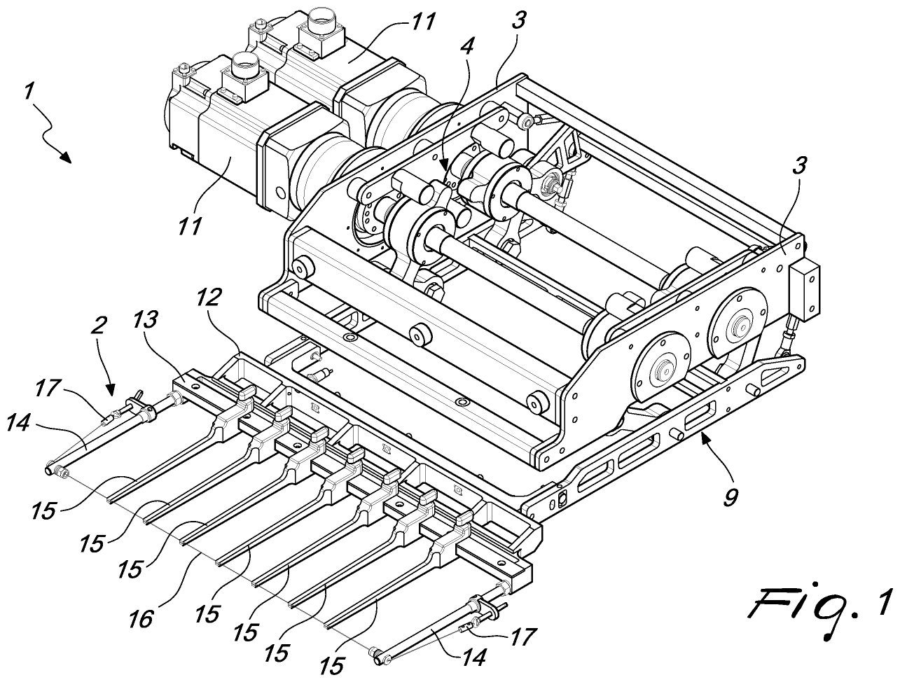

FIG. 2 is a further schematic perspective view of the cutting assembly of FIG. 1;

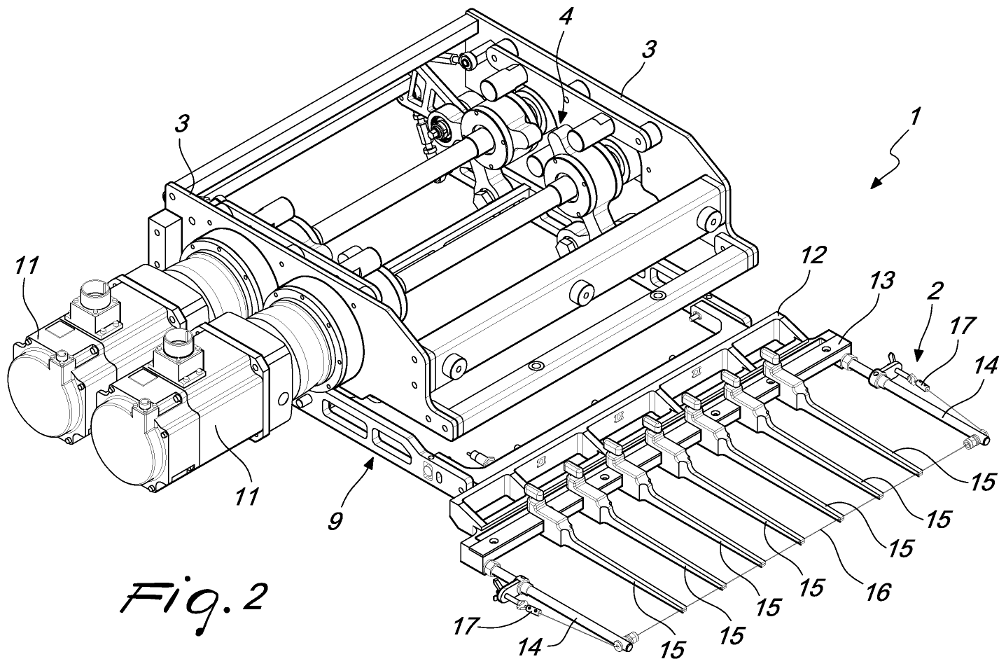

FIG. 3 is a schematic view from above of the cutting assembly of FIG. 1; and

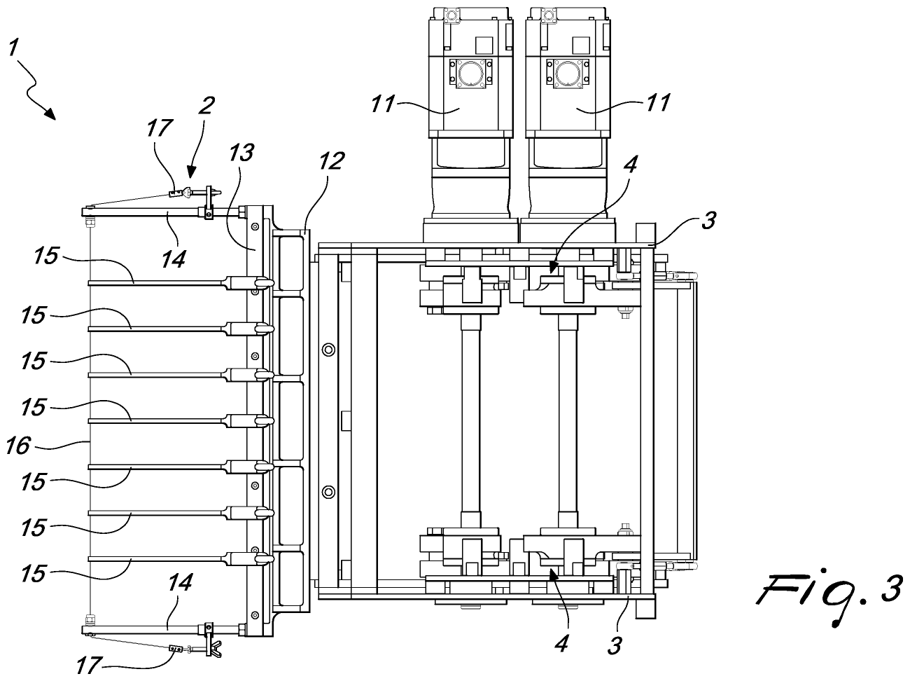

FIG. 4 is a partially cross-sectional schematic side view of the cutting assembly of FIG. 1 in different active positions.

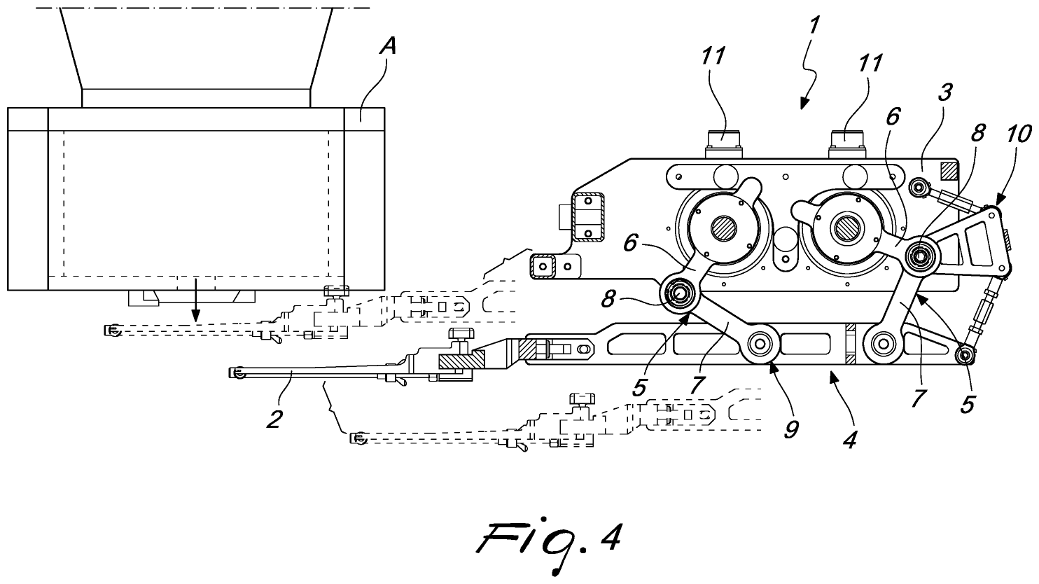

### DETAILED DESCRIPTION OF THE DRAWINGS

With particular reference to the figures, the reference numeral 1 generally designates a cutting assembly for mixtures for food use.

The assembly 1 is intended to be integrated and/or associated with an apparatus for the production of food products, in particular oven-baked products.

This apparatus will comprise a dispenser A of at least one continuous element B constituted by a mixture for food use, with respect to which a cutter 2 of the cutting assembly 1 will have to carry out the portioning according to the specified size standards for the end product (the single portions of mixture will be subjected to a process of baking in an industrial oven).

According to the disclosure the at least one cutter 2 will have to be facing the outlet of the dispensing apparatus A.

The assembly 1 according to the disclosure comprises a fixed frame 3 which is rigidly coupled, and proximate, to the dispensing apparatus A, at least one motorized automatic follower mechanism 4, supporting the at least one cutter 2 and coupled to the frame 3.

The assembly 1 further comprises a control and management unit controlled by the dispensing apparatus A and designed to control the at least one actuator of the at least one motorized automatic follower mechanism 4.

In tandem with the dispensing of the continuous element of mixture by the apparatus A, the cutter 2 will be moved by the motorized automatic follower mechanism 4 so that it follows the advancement of the element of mixture during the cutting operation: this operation ensures a high degree of precision of the cut even when the dispensing of the element of mixture is done at high speed, because the cutter 2 follows the element itself without the possibility of there being relative movements between the two.

The control and management unit, therefore, since the law of motion of the dispensing apparatus A is known (generally it will be a linear motion of the element of mixture at constant speed) will be able to control the actuators present in the follower mechanism 4 to execute a following cut.

In particular, the control and management unit will control the actuators of the assembly 4 to execute a first movement that ensures the preventive alignment of the cutter 2 with the region of the element of mixture to be cut; the actuators will then proceed to make the cutter 2 advance until it notches the element of mixture B; subsequently the actuators will execute a vertical movement of the cutter 2, in the configuration of cutting the element of mixture, for a portion of predefined length, while moving at the same speed as the dispensing of the mixture by the apparatus A; in a final step of the cutting operation, the cutter 2 will be made to retreat again and the actuators will lift it by executing the above mentioned first movement (thus returning it to the initial position).

The assembly 1 according to the disclosure offers great versatility and therefore makes it possible to manage the speed of entry of the cutter 2 into the element of mixture, by synchronizing the motion of the cutter 2 with that of the underlying dispensing apparatus A and by managing the exit speed of the cutter 2 itself from the element on which it has carried out the cut.

Another peculiarity of the assembly 1 is the possibility of setting the vertical stroke so that, if elements of mixture of different thickness are to be cut, it will be possible to program the initial position of the cutter 2 at the start of the cycle, thus making it possible to adapt the assembly 1 according to the disclosure to the execution of any specific cutting operation on any element of mixture.

It should be noted that the assembly 4 will also make it possible to give the cutter 2 a simple alternating motion (that of a traditional guillotine cutter) that is sufficient in cases where the element of mixture is dispensed by the apparatus A at low speed.

With particular reference to an embodiment of undoubted practical and applicative interest, it should be noted that the at least one motorized automatic follower mechanism 4 can advantageously comprise at least one pair of articulated arms 5, each one constituted by a pair of levers 6, 7 which are mutually hinged at an end 8 thereof.

According to this embodiment, the free end of the second levers 7 will be conveniently joined rotatably to a plate 9 which is designed, directly or indirectly, for retaining the cutter 2.

In this embodiment, it should be noted that the pairs of articulated arms 5 can conveniently comprise at least two controlled motors 11, which are controlled by the control and management unit and are coupled to the initial end, which is rotatable with respect to the frame 3, of the articulated arms 5 (in particular of the first levers 6).

It should be noted that the pairs 5 of articulated arms will preferably be two in number, at least one of which will usefully comprise an additional lever mechanism 10, which is articulated with respect to the frame 3 and with respect to corresponding portions of the pair 5 of articulated arms, defining, therewith, an articulated quadrilateral.

The controlled motors 11 controlled by the control and management unit will be brushless motors and therefore will allow complete control of the movements of the plate 9 (and therefore of the cutter 2), behaving like an electronic cam (designed to define a law of motion that can be programmed via the control and management unit).

The choice fell on brushless motors because these make it possible to obtain the best results in terms of control of their dynamics.

It should furthermore be noted that the at least one motorized automatic follower mechanism 4 comprises at least one removable and interchangeable retaining bracket 12 for at least one respective cutter 2.

Generally, the cutter 2 can have a shape structure preferably chosen from among laminar of slender thickness, filament-like of slender thickness, contoured for the specific creation of cutting lines on the fronts of the subdivided portions of mixture, and the like.

With particular reference to the implementation solution shown by way of non-limiting example in the accompanying figures, the cutter 2 will conveniently comprise a supporting beam 13 (which can be removably coupled to the bracket 12 for possible substitution) provided with arms 14 that protrude frontally at its heads and with at least one supporting stem 15 interposed between and parallel to the arms 14.

On the terminal ends of the arms 14 and of the at least one supporting stem 15 there will positively be a wire 16 which is tensioned mechanically and is designed to exert the cutting action on the mixture for food use.

The correct mechanical tension of the wire 16 will be obtained by way of respective conventional tensioners 17.

The present disclosure also extends its protection to include any apparatus for processing mixtures for food use which comprises a dispensing apparatus A of at least one element of mixture for food use that comprises the cutting assembly 1.

It should be noted that the dispensing apparatus A of at least one element of mixture for food use is preferably chosen from an extruder and a lamination element. In particular the assembly 1 according to the disclosure will be particularly effective when it will be used for portioning a continuous element of mixture exiting from an extruder.

In relation to the apparatus that comprises the assembly 1 according to the disclosure, it should be noted that it can comprise respective fixed elements for mechanically cleaning the surfaces of the cutter 2, if such operation is necessary owing to specific characteristics of the mixture being processed.

The fixed cleaning elements could, for example, be constituted by mutually facing brushes or spatulas, through which the cutter 2 can be made to translate, so that the bristles of the brushes or the end edge of the spatulas can remove the residues of mixture from the surfaces of the cutter 2.

The assembly 1 according to the disclosure is particularly versatile in that it can be installed in any apparatus for processing mixtures for food use, even to substitute conventional cutting stations.

The assembly 1 according to the disclosure makes it possible to execute optimal cutting operations even at high dispensing speeds of the element of mixture by the dispenser A.

Purely for the purposes of example, it should be noted that the station is capable of executing approximately 300 cuts per minute, thus ensuring a variable cut length within a fairly broad range (starting from a few millimeters), on an element of mixture B that has a cross-section set by the shape and dimensions of the extrusion head.

It should conveniently be noted that the assembly 1 according to the disclosure and any apparatus that comprises it can advantageously operate on mixtures for food use that are based on cereal flours of leavened and/or non-leavened type, and also on mixtures for food use of different types.

Advantageously the present disclosure solves the above mentioned problems, by providing a cutting assembly 1 for mixtures for food use that can operate substantially at any translation speed of the mixture dispensed by the apparatus A.

Conveniently the assembly 1 according to the disclosure is particularly versatile, being adapted to execute any type of cut on the mixture with any frequency.

Positively the cutting assembly 1 according to the disclosure does not damage and does not deform (in general it does not modify the shape and/or the dimensions) the mixture when executing the cutting operations.

Positively the cutting assembly 1 according to the disclosure is easily and practically implemented and is of low cost: such characteristics make the assembly 1 according to the disclosure an innovation that is safe in use.

The disclosure, thus conceived, is susceptible of numerous modifications and variations, all of which are within the scope of the appended claims. Moreover, all the details may be substituted by other, technically equivalent elements.

In the embodiments illustrated, individual characteristics shown in relation to specific examples may in reality be interchanged with other, different characteristics, existing in other embodiments.

In practice, the materials employed, as well as the dimensions, may be any according to requirements and to the state of the art.

1. A cutting assembly for mixtures for food use configured for functional connection to a dispensing apparatus of at least one continuous element constituted by a mixture for food use, and which is provided with at least one cutter facing toward an exit of said dispensing apparatus, the cutting assembly comprising:
a fixed frame which is rigidly coupled, and proximate, to said dispensing apparatus,
at least one motorized automatic follower mechanism, supporting the at least one said cutter and coupled to said frame, and
a control and management unit controlled by the said dispensing apparatus and designed to control the at least one actuator of said at least one motorized automatic follower mechanism.

2. The cutting assembly according to claim 1, wherein said at least one motorized automatic follower mechanism comprises at least one pair of articulated arms, each articulated arm constituted by a pair of levers which are mutually hinged at an end thereof, a free end of said second levers being joined rotatably to a plate which is designed, directly or indirectly, for retaining said cutter.

3. The cutting assembly according to claim 2, wherein said pair of articulated arms comprises at least two controlled motors, which are controlled by said control and management unit and are coupled to the initial end, which is rotatable with respect to said frame, of said articulated arms.

4. The cutting assembly according to claim 3, wherein said pairs of articulated arms are two in number, at least one of which comprises an additional lever mechanism which is articulated with respect to said frame and to respective portions of said pair of articulated arms, defining, therewith, an articulated quadrilateral.

5. The cutting assembly according to claim 3, wherein said controlled motors controlled by said control and management unit are brushless motors.

6. The cutting assembly according to claim 1, wherein at least one motorized automatic follower mechanism comprises at least one removable and interchangeable retaining bracket for at least one respective cutter.

7. The cutting assembly according to claim 6, wherein said cutter has a shape structure chosen from among laminar of slender thickness, filament of slender thickness, and contoured for a specific creation of cutting lines on fronts of subdivided portions of mixture.

8. The cutting assembly according to claim 7, wherein said cutter comprises a supporting beam provided with arms that protrude frontally at heads thereof and with at least one supporting stem interposed between and parallel to said arms, on the terminal ends of said arms and of said at least one supporting stem there being a wire which is tensioned mechanically and is designed to exert the cutting action on the mixture for food use.

9. An apparatus for processing mixtures for food use, which comprises a dispensing apparatus of at least one element of mixture for food use with substantially continuous longitudinal extension, further comprising a cutting assembly provided with:
a fixed frame which is coupled, and proximate, to said dispensing apparatus,
at least one motorized automatic follower mechanism, supporting the at least one said cutter and coupled to said frame, and
a control and management unit controlled by the said dispensing apparatus and designed to control the at least one actuator of said at least one motorized automatic follower mechanism.

10. The apparatus according claim 9, wherein said dispensing assembly of at least one element of mixture for food use with substantially continuous longitudinal extension is chosen from an extruder and a lamination element.
